(19) United States
(12) Patent Application Publication
(10) Pub. No.: US 2022/0290319 A1
(43) Pub. Date: Sep. 15, 2022

(54) CROSS-FLOW WATER ELECTROLYSIS

(71) Applicant: THYSSENKRUPP UHDE CHLORINE ENGINEERS GMBH, Dortmund (DE)

(72) Inventors: Jens Wilhelm KUHLMANN, Dortmund (DE); Dirk HOORMANN, Werne a.d. Lippe (DE); Joerg KOLBE, Bochum (DE); Lukas LUEKE, Dortmund (DE); Gregor Damian POLCYN, Dortmund (DE)

(73) Assignee: THYSSENKRUPP UHDE CHLORINE ENGINEERS GMBH, Dortmund (DE)

(21) Appl. No.: 17/639,779

(22) PCT Filed: Aug. 19, 2020
(86) PCT No.: PCT/EP2020/073215

§ 371 Date: Mar. 2, 2022

(30) Foreign Application Priority Data
Sep. 5, 2019 (DE) 10 2019 123 858.7

(51) Int. Cl. C25B 15/08; C25B 1/04; C25B 9/19; C25B 13/08; C25B 11/03; C25B 11/042; C25B 11/046

(52) U.S. Cl. CPC C25B 15/083; C25B 1/04; C25B 9/19; C25B 13/08; C25B 11/03; C25B 11/042; C25B 11/046; C25B 15/087

(57) ABSTRACT

Processes for alkaline electrolysis of water may involve pumping an electrolyte in a circuit between an anode half-cell and a cathode half-cell so as to keep the electrolyte concentration constant throughout the electrolysis process. One such process may involve supplying electrolyte from a first liquid reservoir to the anode half-cell and supplying an anolyte flowing out of the anode half-cell to an anodic gas separator, where gas is separated from the anolyte. The electrolyte may be supplied from a second liquid reservoir to the cathode half-cell and a catholyte flowing out of the cathode half-cell may be supplied to a cathodic gas separator, where gas is separated from the catholyte. Gas-stripped anolyte from the anodic gas separator may be returned to the second liquid reservoir and gas-stripped catholyte from the cathodic gas separator may be returned to the first liquid reservoir.

### TECHNICAL FIELD

The present invention relates to processes for the alkaline electrolysis of water in which an electrolyte is pumped in the circuit between an anode half-cell and a cathode half-cell so as to keep the electrolyte concentration constant throughout the electrolysis process. Disadvantages, such as the formation of a Donnan potential, and the formation of flow currents can be largely suppressed by this process regime. The present invention further relates to electrolysis devices with which the specified process can be executed.

### PRIOR ART

The principle of water electrolysis has been known for around 200 years and is used to generate hydrogen and oxygen gas from water. From a technical viewpoint, acidic water electrolysis nowadays plays only a minor role, whereas alkaline electrolysis processes have found commercial application on a large scale. In alkaline electrolysis, an approximately 25-30% alkali solution, for example in the form of sodium hydroxide or potassium hydroxide solution, is used as the electrolyte and is exposed to a current applied to the cell. Here it is common to use separate cathode and anode circuits so as to prevent the resulting product gases (oxygen and hydrogen) from mixing. The electricity results in the generation of hydrogen at the cathode and oxygen at the anode.

Whereas water electrolysis was formerly of minor importance for the production of hydrogen because hydrogen could be produced more inexpensively using natural gas, oil or coal for example, water electrolysis is nowadays of growing importance. Although this is on the one hand due to non-renewable raw materials such as oil and gas becoming increasingly scarce, its growing importance can also be explained by the greater availability of electricity that is generated from wind or sun and therefore not available continuously. The electrolysis reaction can be harnessed here, for example in combination with fuel cells, to maintain constancy in power generation because, whenever surplus electrical energy is available, water can be split into hydrogen and oxygen, which, when energy demand is high, can be converted back into energy with the aid of fuel cells. Moreover, the addition of carbon monoxide or carbon dioxide allows hydrogen to be converted into methane, which can then be fed into the natural gas grid, preferably for the generation of heat. Lastly, the hydrogen produced can also be mixed in small proportions with natural gas and burned, for example to generate heat.

Since it is expected that the generation of intermittent electricity from wind or sun will increase significantly in the coming years, efforts are being made to increase efficiency in the storage of surplus energy. A problem that is currently still associated with the production of hydrogen from water is that the energy yield/efficiency of the electrolysis devices available on the market is inadequate. For instance, the energy efficiency in the electrolysis of water is currently generally around 70%, although there are already some electrolysis devices available that have an efficiency of almost 80%.

Nevertheless, their efficiency still has room for improvement, especially when compared to alternative electricity storage technologies such as accumulators. Compared to accumulators, water electrolysis does however have the significant advantage that the amount of energy that can be stored is practically unlimited, since water is available in adequate amounts and there would also be adequate capacity for storing hydrogen.

Against the background of the situation described, there is a need for an electrolysis process having improved efficiency beyond that of known electrolysis processes.

In conventionally known and used water electrolysis processes, anode and cathode electrolyte circuits that are separate from one another are often used today, i.e. there is no exchange of electrolyte between the cathode circuit and anode circuit (also referred to as the “separated circles” process). However, a process regime of this kind has the disadvantage that in the course of the electrolysis process a difference in the concentration of the alkaline electrolyte builds up between the anode side and the cathode side. This leads to a rise in the cell voltage due to the formation of a Donnan potential and has a negative effect on the efficiency of the device. An example of such a process regime is described for example in WO 2015/007716 A1, which discloses an electrolysis cell having a cathode side and an anode side that are separated by a cation-exchange membrane. This application is aimed at providing oxygen and hydrogen of the highest possible purity, which means that meticulous attention must be paid here to avoiding mixing of the cathode and anode electrolysates.

In another approach, the electrolyte passes in each case through the cathode half-cell and anode half-cell in separate cycles. The electrolyte fractions draining from the anode half-cell and cathode half-cell are then channeled into a common tank and mixed before the electrolyte is recycled to the cathode half-cell and anode half-cell (also referred to as the “divided circles” process). However, this alternative process too is associated with the disadvantage of electrolyte concentration differences between the two half-cells, which in turn lead to a Donnan potential and thus to reduced efficiency of the device.

In addition, the divided circles process has the problem that, at high current densities, cross-currents can develop across the common tank. This too has a negative effect on the efficiency of the process. The cause of these various disadvantages is not just the electrochemical reaction itself, but also the electrolytic connection between the anode side and cathode side in the divided circles process.

The present invention is concerned with the problem of ensuring the highest possible efficiency in the water electrolysis, while at the same time seeking to avoid as far as possible the disadvantages of the prior art.

### SUMMARY OF THE INVENTION

To solve the problems described hereinabove, the present invention proposes in one embodiment a process for the alkaline electrolysis of water with an electrolyte in an electrolyzer that comprises at least an electrolysis cell, a cathodic gas separator, an anodic gas separator, a first liquid reservoir for the electrolyte and a second liquid reservoir for the electrolyte that is separate from the first liquid reservoir, wherein the electrolysis cell comprises an anode half-cell having an anode, a cathode half-cell having a cathode, and a separator arranged between the anode half-cell and cathode half-cell, wherein a current is applied to the electrolyzer filled with the electrolyte so as to carry out the electrolysis, wherein electrolyte is supplied from the first liquid reservoir to the anode half-cell and the anolyte flowing out of the anode half-cell is supplied to the anodic gas separator, in which the gas is separated from the anolyte, and wherein electrolyte is supplied from the second liquid reservoir to the cathode half-cell and the catholyte flowing out of the cathode half-cell is supplied to the cathodic gas separator, in which the gas is separated from the catholyte, characterized in that the gas-stripped anolyte from the anodic gas separator is returned to the second liquid reservoir and the gas-stripped catholyte from the cathodic gas separator is returned to the first liquid reservoir.

For a process regime of this kind, a largely constant electrolyte concentration in the anode half-cell and cathode half-cell was firstly observed, which is manifested in low voltages required for the process regime. Secondly, it was surprisingly observed that, despite the electrolyte being supplied from the anode half-cell to the cathode half-cell, there is only minimal mixing of the product gases through the gas fractions dissolved in the electrolyte, this movement being in the ppm range.

The separator mentioned above is preferably a diaphragm, in particular a semipermeable diaphragm. Examples of suitable diaphragm materials that may be mentioned are zirconium oxide/polysulfonic acid membranes. Another diaphragm material that is suitable in the context of the invention is oxide-ceramic materials, such as those described in EP 0 126 490 A1.

Alternatively, the separator may also be a membrane, in particular a cation-exchange membrane, however. Such membranes may be based on sulfonated polymers, and on perfluorinated sulfonated polymers in particular, and are available for example under the trade name Nafion from DuPont. Particularly suitable cation-exchange membranes are non-reinforced single-layer sulfonated membranes, as are commonly used for fuel cell applications.

The electrolyte used in the process according to the invention is preferably an aqueous alkali solution and more preferably an aqueous sodium hydroxide solution or potassium hydroxide solution. The concentration of these alkali solutions is advantageously within a range from 8% to 45% by weight and more preferably within a range from 20% to 40% by weight.

As regards the electrolyte flow rate in relation to cell volume through the anode half-cell and cathode half-cell, the present invention is not subject to any significant restrictions and it will be evident to those skilled in the art that the flow rate is guided also by the size of the cathode half-cell and anode half-cell. Although the flow rate should be sufficiently high that no significant concentration difference between the electrolytes in the cathode half-cell and in the anode half-cell can develop in the course of the electrolysis reaction, high flow rates are associated with higher energy costs relating to pumping power, which means that a very high flow rate reduces the efficiency of the process. Particularly suitable electrolyte flow rates in relation to cell volume have in the context of the present invention been found to be a range of 1 to 6 L_{electrolyte}/h·L_{half-cell volume} and especially 2 to 4 L_{electrolyte}/h·L_{half-cell volume}.

As regards temperature, a higher temperature results in higher ion mobility, which means that a higher temperature has a positive effect on efficiency. However, the aggressiveness of the electrolyte toward the material of the electrolysis cell and the vapor pressure of the electrolyte increases, particularly in the case of strongly alkaline electrolytes, which places greater demands on the materials used to construct the electrolyzer. The temperature during the execution of the electrolysis process is particularly suitably within a range from 50 to 95° C., preferably within a range from 65 to 92° C., and more preferably within a range from 70 to 90° C.

The process according to the invention can be advantageously further refined by carrying out the electrolysis at a pressure above atmospheric pressure. For example, the electrolysis can be carried out at a pressure within the range from 1 to 30 bar and in particular from 5 to 20 bar. A higher pressure has the advantage that the gases generated during the electrolysis process remain dissolved in the electrolyte, whereas at standard pressure they may be released as gas bubbles, which increase the resistance of the electrolyte solution. On the other hand, a higher pressure does however also lead to higher systemic demands on the material, such that it may make sense for cost reasons to execute the process at a pressure of not more than 1 bar, preferably not more than 500 mbar, and particularly preferably not more than 250 bar above atmospheric pressure.

In the process according to the invention it is also advantageous when the electrolysis is carried out at a current density within the range of up to 25 kA/m² and preferably up to 15 kA/m². At a current density less than 3 kA/m², the efficiency of the process decreases. Current densities of more than 25 kA/m² generally place such high demands on the material that they are unfavorable from an economic viewpoint.

In the process described hereinabove, electrolyzers are used that have a first liquid reservoir for the electrolyte and a second liquid reservoir for the electrolyte that is separate from the first liquid reservoir and into which the electrolyte from the cathodic gas separator and anodic gas separator is introduced. While the process advantageously provides for the use of separate liquid reservoirs, these are not necessary when the electrolyte is introduced from the respective gas separator into the respective other half-cell, without passage through a liquid reservoir (i.e. from the cathodic gas separator into the anode half-cell and vice versa).

A further aspect of the present invention relates therefore to a process for the alkaline electrolysis of water with an electrolyte in an electrolyzer that comprises at least an electrolysis cell, a cathodic gas separator and an anodic gas separator, wherein the electrolysis cell comprises an anode half-cell having an anode, a cathode half-cell having a cathode, and a separator arranged between the anode half-cell and cathode half-cell, wherein a current is applied to the electrolyzer filled with the electrolyte so as to carry out the electrolysis, wherein electrolyte from the cathodic gas separator is supplied exclusively to the anode half-cell and the anolyte flowing out of the anode half-cell is supplied to the anodic gas separator, in which the gas is separated from the anolyte, and wherein electrolyte from the anodic gas separator is supplied exclusively to the cathode half-cell and the catholyte flowing out of the cathode half-cell is supplied to the cathodic gas separator, in which the gas is separated from the catholyte.

For preferred embodiments of this process, reference is made to the statements hereinabove, which apply by analogy to this process.

A further aspect of the present invention relates to a device for the electrolytic splitting of water into hydrogen and oxygen that comprises an anode half-cell having an anode, a cathode half-cell having a cathode, and a separator arranged between the anode half-cell and cathode half-cell, wherein the anode half-cell and the cathode half-cell are each in fluid communication with a liquid reservoir that is separate from the anode half-cell and from the cathode half-cell, and wherein the anode half-cell and the cathode half-cell are each in fluid communication with a gas separator that is separate from the anode half-cell and from the cathode half-cell. In this device, the gas separator of the anode half-cell is in fluid communication with the liquid reservoir of the cathode half-cell and not in fluid communication with the liquid reservoir of the anode half-cell, while the gas separator of the cathode half-cell is in fluid communication with the first liquid reservoir of the anode half-cell and not in fluid communication with the first liquid reservoir of the cathode half-cell. The latter distinguishes the device from a device for executing a divided circles process, since the respective gas separators are here in fluid communication with a common liquid reservoir from which the electrolyte is supplied both into the anode half-cell and into the cathode half-cell.

Suitable as the separator in the context of this device according to the invention are in particular the materials specified hereinabove for the process according to the invention.

In the device according to the invention, the electrolyte is advantageously channeled into the respective half-cells of the cell with the aid of suitable infeed and outfeed devices. This can be done for example with the aid of a pump.

The device according to the invention is advantageously made of a material, particularly in the region of the electrolysis cell, that is not attacked by the electrolyte or is attacked only to a very minor degree. An example of such a material is nickel, but also PPS and, depending on the alkali concentration in the electrolyte, also nickel-alloyed stainless steels.

The device according to the invention is in addition advantageously designed when the anode consists of a nickel-containing material. Examples of suitable nickel-containing materials are Ni/Al or Ni/Co/Fe alloys or nickel coated with metal oxides such as those of the perovskite or spinel type. Particularly suitable metal oxides are in this context lanthanum perovskites and cobalt spinels. A particularly suitable anode material is Ni/Al coated with CO₃O₄. The anode here refers only to that component in the electrolysis which is in direct contact with the electrolyte liquid.

In addition or independently thereof, it may be preferable when the cathode consists of a nickel-containing material. Nickel-containing materials suitable for the cathode are Ni—Co—Zn, Ni—Mo or Ni/Al/Mo alloys or Raney nickel (Ni/Al). In addition, the cathode may also be made from Raney nickel in which some or most of the aluminum has been extracted so as to create a porous surface. It is also possible to use a cathode that largely consists of nickel (i.e. to an extent of at least 80% by weight, preferably at least 90% by weight) and has a coating of Pt/C (platinum on carbon).

It may further be preferable when the anode and/or the cathode is present as wire mesh electrode or in the form of an expanded metal or punched sheet metal, it being preferable when at least the anode is in such a form. The anode can in this case also be provided with a catalytic coating. If a cation-exchange membrane is used as the separator, the anode is advantageously positioned in direct contact with the membrane.

The anode may also be in contact with the wall of the anode half-cell via a current collector; this current collector may consist of a porous metal structure such as a nickel or steel foam or wire mesh. Likewise, the cathode may also be in contact with the wall of the cathode half-cell via a current collector, which may likewise consist of a porous metal structure such as a nickel or steel foam or wire mesh.

An electrolysis cell that can be included particularly advantageously in the process according to the invention or the device according to the invention is described for example in WO 2015/007716 A1.

For the above-described device too, it is not absolutely necessary for it to have liquid reservoirs connected upstream of the anode half-cell and cathode half-cell in the direction of flow. These liquid reservoirs can be omitted provided it is ensured that the electrolyte flowing out of the cathodic gas separator is supplied exclusively to the anode half-cell and that the electrolyte flowing out of the anodic gas separator is supplied exclusively to the cathode half-cell. In a further embodiment, the present invention therefore also relates to a device for the electrolytic splitting of water into hydrogen and oxygen that comprises an anode half-cell having an anode, a cathode half-cell having a cathode, and a separator arranged between the anode half-cell and cathode half-cell, wherein the anode half-cell and the cathode half-cell are each in fluid communication with a gas separator that is separate from the anode half-cell and from the cathode half-cell. In this device, the gas separator of the anode half-cell is in fluid communication with the cathode half-cell and not in fluid communication with the anode half-cell, while the gas separator of the cathode half-cell is in fluid communication with the anode half-cell and not in fluid communication with the cathode half-cell.

As mentioned hereinabove, water is removed from the electrolyte by the electrolysis process, which, to avoid a rise in the concentration of the electrolyte, should in the course of the electrolysis process be advantageously compensated by adding water to the electrolysis process. For this purpose, the device according to the invention preferably has a conduit supplying water to the electrolyte circuit. The water can in principle be added at any point in the electrolyte circuit, such as in the region of the liquid reservoirs of the cathode half-cell and/or anode half-cell, of the gas separators of the cathode half-cell and/or anode half-cell, and/or of the cathode half-cell and/or anode half-cell, or in conduits that combine these components of the device according to the invention.

However, it is preferable that the water is not added in the cathode half-cell and/or anode half-cell, since there is the risk of an inhomogeneous electrolyte concentration forming there that can reduce the efficiency of the process.

### BRIEF DESCRIPTION OF THE DRAWINGS

FIG. 1 describes a prior art process in which the electrolyte flows for the anode half-cell and cathode half-cell are routed as separate cycles. The electrolysis cell 1 is formed by an anode half-cell 2 and a cathode half-cell 3, which are separated from one another by a separator 4. Both the anode half-cell and cathode half-cell have a respective gas separator 5 and 6 that is connected downstream of respectively the cathode half-cell and anode half-cell in the direction of flow. In the gas separator, the gas generated in the anode half-cell and cathode half-cell is separated from the liquid, which then flows into a respective separate liquid reservoir 7 and 8, from which the electrolyte is fed back into the anode half-cell 2 and the cathode half-cell 3.

FIG. 2 describes the process known in the prior art as the divided circle process. This is executed in an analogous manner to the process having separate electrolyte cycles, with the exception that instead of two separate liquid reservoirs 7 and 8 there is a common liquid reservoir 9 into which the electrolyte flows draining from respective gas separators 5 and 6 are fed and from which they are channeled separately in each case into the anode half-cell and into the cathode half-cell.

FIG. 3 describes a process according to the present invention, which differs from the process having separate electrolyte cycles in that the electrolyte flow obtained from the gas separator of the anode half-cell 5 is introduced exclusively into the liquid reservoir of the cathode half-cell 8, while the electrolyte flow from the gas separator of the cathode half-cell 6 is introduced exclusively into the liquid reservoir of the anode half-cell 7.

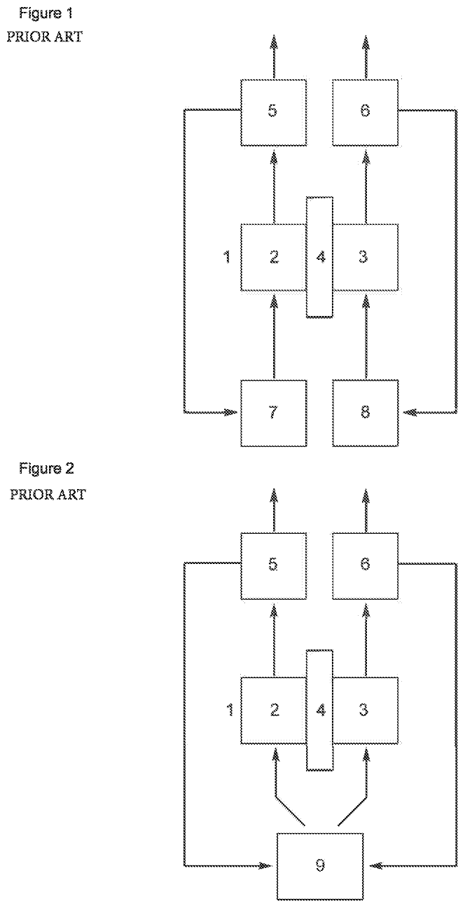

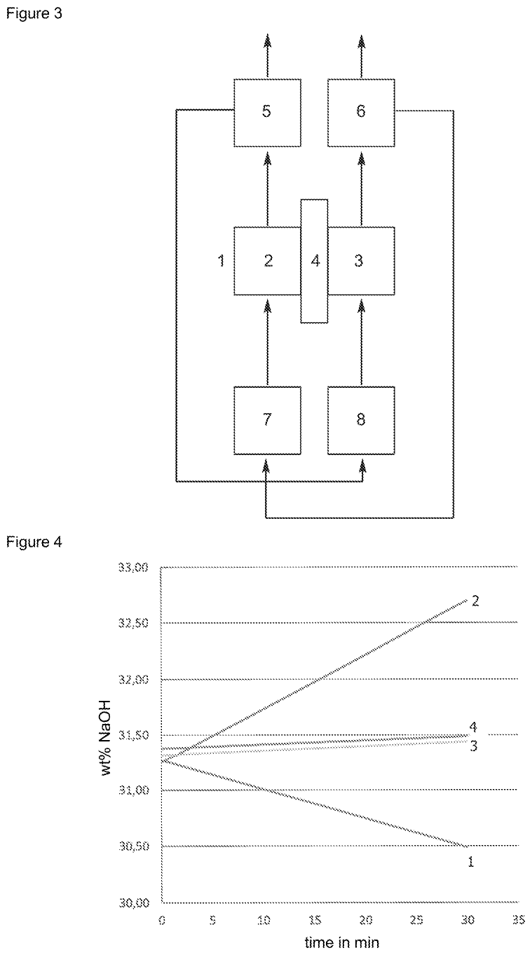

It will be evident to those skilled in the art that a variety of cells as have been described hereinabove can be used as modular elements of an electrolyzer. For example, an electrolyzer can be obtained in which an arrangement of two or more cells electrically connected in series may be present.

The present invention is illustrated in more detail hereinbelow with reference to a few examples, which should not however be understood as limiting for the scope of protection of the present application.

### EXAMPLE 1

An electrolysis device according to the prior art in which the electrolyte is fed through the cathode half-cell and anode half-cell of the electrolysis cell in separate cycles was compared with a corresponding process regime according to the present invention. For this, the respective electrolysis devices were filled with electrolytes having varying NaOH concentrations. The electrolysis cell used was a cell having a surface area of 120 cm². The electrolysis was in each case carried out at temperatures of 80° C.

After the process had been run for some time (30 min) at a current density of 6 kA/m² the sodium hydroxide concentration in the anode half-cell and cathode half-cell and the voltage were in each case determined. The results are shown in Table 1 below.

TABLE 1

| | NaOH | NaOH | |
|---|---|---|---|
| Process | concentration | concentration | |
| regime | at anode [%] | at cathode [%] | Voltage [V] |
| SC | 32.41 | 32.98 | 2.61 |
| SC | 26.18 | 28.39 | 2.34 |
| SC | 20.97 | 23.64 | 2.20 |
| SC | 16.01 | 20.75 | 2.17 |
| SC | 13.17 | 18.32 | 2.17 |
| CF | 15.0 | 15.0 | 2.12 |

SC = separated circles;
CF = cross-flow (according to the invention)

### EXAMPLE 2

In a further experiment, a process regime according to the invention was compared with a process regime in which the electrolyte draining from the gas separator of the anode half-cell and cathode half-cell was fed to a common liquid reservoir (divided circles process). These measurements too were carried out at a temperature of 80° C. and a current density of 6 kA/m². In this experiment, the development of the NaOH concentration in the electrolyte was determined over time in each case. The results of these investigations are shown in FIG. 4.

The investigations found that when a process regime was executed according to the divided circles process (FIG. 2), a significant difference in the NaOH concentration between the anode half-cell and cathode half-cell was already detectable after about 30 minutes (the concentration was about 30.5% by weight on the anode side (1 in FIG. 4) and about 32.7% by weight on the cathode side (2 in FIG. 4) at an initial concentration of 31.3% by weight NaOH on both sides). By contrast, with a process regime according to the invention the NaOH concentration increased only slightly from about 31.3% by weight to 31.4% by weight on the anode side (3 in FIG. 4) and from 31.4% by weight to about 31.5% by weight on the cathode side (4 in FIG. 4).

It can accordingly be seen that, in a process regime according to the invention, the sodium hydroxide concentration in the electrolyte is able to establish a largely constant level over time, which is not possible either in a process regime having separate cycles or in a process regime in which the electrolytes are intermittently mixed together in a common reservoir. This results in appreciably lower voltages.

### LIST OF REFERENCE NUMERALS

1 Electrolyzer
2 Anode half-cell
3 Cathode half-cell
4 Separator
Gas separator of the anode half-cell
6 Gas separator of the cathode half-cell
7 Liquid reservoir of the anode half-cell
8 Liquid reservoir of the cathode half-cell
9 Common liquid reservoir for anode half-cell and cathode half-cell

1.-12. (canceled)

13. A process for alkaline electrolysis of water with electrolyte in an electrolyzer comprising an electrolysis cell, a cathodic gas separator, an anodic gas separator, a first liquid reservoir for the electrolyte, and a second liquid reservoir for the electrolyte that is separate from the first liquid reservoir, wherein the electrolysis cell comprises an anode half-cell having an anode, a cathode half-cell having a cathode, and a separator arranged between the anode half-cell and the cathode half-cell, the process comprising:
applying a current to the electrolyzer filled with the electrolyte to perform electrolysis;
supplying the electrolyte from the first liquid reservoir to the anode half-cell and supplying an anolyte flowing out of the anode half-cell to the anodic gas separator, where gas is separated from the anolyte;
supplying the electrolyte from the second liquid reservoir to the cathode half-cell and supplying a catholyte flowing out of the cathode half-cell to the cathodic gas separator, where gas is separated from the catholyte; and
returning gas-stripped anolyte from the anodic gas separator to the second liquid reservoir and returning gas-stripped catholyte from the cathodic gas separator to the first liquid reservoir.

14. The process of claim 13 wherein the electrolyte comprises aqueous sodium hydroxide solution or potassium hydroxide solution.

15. The process of claim 14 comprising using the aqueous sodium hydroxide solution or the potassium hydroxide solution in a concentration within a range of 8% to 45% by weight.

16. The process of claim 13 comprising establishing in the electrolyzer an electrolyte flow rate relative to a cell volume within a range from 1 to 6 L_{electrolyte}/h·L_{half-cell volume}.

17. The process of claim 13 comprising performing the electrolysis at a temperature within a range from 50 to 95° C.

18. The process of claim 13 comprising performing the electrolysis at a pressure within a range of up to 30 bar.

19. The process of claim 13 comprising performing the electrolysis at a current density within a range of up to 25 kA/m².

20. A device for electrolytically splitting water into hydrogen and oxygen, the device comprising:
an anode half-cell having an anode;
a cathode half-cell having a cathode; and
a separator arranged between the anode half-cell and cathode half-cell,
wherein the anode half-cell and the cathode half-cell are each in fluid communication with a liquid reservoir that is separate from the anode half-cell and from the cathode half-cell,
wherein the anode half-cell and the cathode half-cell are each in fluid communication with a gas separator that is separate from the anode half-cell and from the cathode half-cell,
wherein the gas separator of the anode half-cell is in fluid communication with the liquid reservoir of the cathode half-cell and not in fluid communication with the liquid reservoir of the anode half-cell,
wherein the gas separator of the cathode half-cell is in fluid communication with the liquid reservoir of the anode half-cell and not in fluid communication with the liquid reservoir of the cathode half-cell.

21. The device of claim 20 wherein the separator has a semipermeable diaphragm or a perfluorinated sulfone membrane.

22. The device of claim 20 wherein the anode comprises a nickel-containing material.

23. The device of claim 20 wherein the anode consists of nickel.

24. The device of claim 20 wherein the cathode comprises a nickel-containing material.

25. The device of claim 20 wherein the cathode consists of nickel.

26. The device of claim 20 wherein the anode and the cathode are configured as a wire mesh electrode, as expanded metal, or as punched sheet metal.

27. The device of claim 20 wherein the anode is configured as a wire mesh electrode, as expanded metal, or as punched sheet metal.

28. The device of claim 20 wherein the cathode is configured as a wire mesh electrode, as expanded metal, or as punched sheet metal.
